(19) United States
(12) Patent Application Publication
(10) Pub. No.: US 2016/0211931 A1
(43) Pub. Date: Jul. 21, 2016

(54) RECEPTION DEVICE AND RECEPTION METHOD, COMPUTER PROGRAM, AND EXTERNAL DEVICE

(71) Applicant: SONY CORPORATION, Minato-ku, Tokyo (JP)

(72) Inventors: Kazuyuki TAKAHASHI, Chiba (JP); Taketoshi YAMANE, Kanagawa (JP)

(73) Assignee: SONY CORPORATION, Minato-ku, Tokyo (JP)

(21) Appl. No.: 14/916,910

(22) PCT Filed: Sep. 12, 2014
(86) PCT No.: PCT/JP2014/004729

§ 371 Date: Mar. 4, 2016

(30) Foreign Application Priority Data
Oct. 18, 2013 (JP) 2013-217719

(51) Int. Cl. H04H 20/59; H04N 21/81

(52) U.S. Cl. CPC H04H 20/59; H04N 21/814

(57) ABSTRACT

Provided is a reception device configured to receive a broadcast signal on which emergency alert information is superimposed and send out an alert properly. The reception device is configured to include a tuner that tunes and receives a broadcast signal, a demodulator that demodulates a physical layer level of the broadcast signal, and an alert device that sends out an alert of audio, text display, or the like according to the emergency alert information superimposed on the physical layer of the broadcast signal. Since an activation time is short with a simple configuration, an alert is sent out immediately even from a standby state when the emergency alert information is detected. Also, power consumption is small. Thus, even when all of the reception devices in an area where an emergency alert is sent out are concurrently activated, power to be supplied is not short.

### CROSS REFERENCE TO RELATED APPLICATIONS

This application claims the benefit of Japanese Priority Patent Application JP2013-217719 filed on Oct. 18, 2013, the entire contents of which are incorporated herein by reference.

### TECHNICAL FIELD

The present technology disclosed in the present specification relates to a reception device and a reception method of receiving a broadcast signal on which emergency alert information is superimposed and sending out an alert, an external device of the reception device, and a computer program.

### BACKGROUND ART

People's lives are exposed to a variety of dangerous situations, for example, natural disasters such as earthquake and tsunami caused by earthquake, typhoon or heavy rain, windstorm, tornado, flood, and mountain fire and large-scale terrorism. Further, travelling situations (for example, disruption of departure and arrival times of school buses) of transportations or school information (for example, a change in attending and leaving time of school, lecture cancellation, and closing caused due to spread of infectious diseases) may cause dangerous situations. For this reason, it is necessary to inform residents in target areas of an emergence alert as quickly as possible to urge the residents of evacuate the areas.

A government agency such as the meteorological agency generally provides emergency alert information at the time of disaster. Broadcast service of televisions, radios, or the like can be used to notify people of the emergency alert information. For example, in terrestrial digital broadcast of the ISDB-T (Integrated Services Digital Broadcasting-Terrestrial, ARIB standard STD-B31) scheme, a signal transmitting an emergency alert of an emergency alert information descriptor is defined in a PMT (Program Management Table) packet of a program specifying information.

For example, there has been suggested a structure in which a reception device is informed of emergency alert information by performing an operation to suppress standby power consumption and activating the reception device which has not be powered on. A reception device of a terrestrial digital broadcast of the ISDB-T scheme has a reception function for a transmission control signal to detect an activation flag for emergency alert broadcast stored in a TMCC (Transmission and Multiplexing Configuration Control) carrier provided to transmit information relevant to a demodulation operation of the reception device when no power is supplied at a normal operation of the reception device. When the activation flag for the emergency alert broadcast is 1 (emergency alert broadcast is present), the reception device can be powered on to urge the reception device to view emergency alert broadcast (for example, see PTL 1).

Further, there has been disclosed a digital broadcast system which urges a reception device to be powered on or to switch a channel at the time of emergency alert information when the reception device is not powered on or receives another channel (for example, see PTL 2). When the reception device receives the TMCC signal or an AC signal in a partial reception segment, the reception device is powered on or switches the channel, and then reproduces other disaster and prevention information, and video and audio.

### CITATION LIST

### Patent Literature

PTL 1: JP 2006-319771A
PTL 2: JP 2007-243936A

### SUMMARY

### Technical Problem

It is desirable to provide an excellent reception device and reception method capable of receiving a broadcast signal on which emergency alert information is superimposed and sending out an alert properly, an external device of the reception device, and a computer program.

### Solution to Problem

The present application was made in view of the above situation and a technology according to an embodiment of the present disclosure includes circuitry configured to:

receive a transmission of a physical layer frame including emergency alert information;

demodulate the received physical layer frame;

detect the emergency alert information; and

provide an alert based on the emergency alert information obtained through the demodulation.

Further, a technology according to an embodiment of the present disclosure includes circuitry configured to:

receive a transmission of a physical layer frame including emergency alert information;

demodulate the received physical layer frame;

detect the emergency alert information; and

retransmit the emergency alert information obtained through the demodulation to an external device via a communication medium.

According to an embodiment of the present disclosure, in the reception device, the physical layer frame is transmitted on a broadcast channel assigned to a broadcast station and includes tuning information used to tune to the broadcast channel.

According to an embodiment of the present disclosure, the circuitry is configured to output audio according to the emergency alert information.

According to an embodiment of the present disclosure, in the reception device, the circuitry is configured to:

store a plurality of audio files,

select one of the plurality of audio files according to a type of the emergency alert information, and

output the selected one of the plurality of audio files.

According to an embodiment of the present disclosure, in the reception device, the circuitry is configured to aurally output a reading of the emergency alert information with a text format.

According to an embodiment of the present disclosure, in the

circuitry is configured to output visual information according to the emergency alert information.

According to an embodiment of the present disclosure, in the reception device, the emergency alert information to be retransmitted includes text information.

According to an embodiment of the present disclosure, in the reception device, the emergency alert information to be retransmitted includes bitmap information in which audio message is defined.

According to an embodiment of the present disclosure, in the reception device, the emergency alert information to be retransmitted includes CAP (Common Alerting Protocol) information or a digest of the CAP information.

According to an embodiment of the present disclosure, in the reception device, the emergency alert information to be retransmitted includes extension information for the external device.

According to an embodiment of the present disclosure, in the reception device, the emergency alert information to be retransmitted includes a url or an abbreviated url for accessing more detailed information.

According to an embodiment of the present disclosure, in the reception device, the circuitry is configured to retransmit the emergency alert information to the external device which is detected through device discovery according to an UPnP (Universal Plug and Play) standard protocol.

According to an embodiment of the present disclosure, in the reception device, the circuitry is configured to retransmit the emergency alert information to the external device according to an unidirectional (one-way) transmission method of the UPnP.

According to an embodiment of the present disclosure, in the reception device, the physical layer frame used to retransmit the emergency alert information includes an automatic activation signal for automatically activating the external device.

Further, a technology according to an embodiment of the present disclosure is a reception method of a reception device including:

receiving, by circuitry of the reception device, a transmission of a physical layer frame including emergency alert information;

demodulating, by the circuitry, the received physical layer frame;

detecting, by the circuitry, the emergency alert information; and

providing an alert based on the emergency alert information obtained in the demodulating.

Further, a technology according to an embodiment of the present disclosure is a reception method of a reception device including:

receiving, by circuitry of the reception device, a transmission of a physical layer frame including emergency alert information;

demodulating, by the circuitry, the received physical layer frame;

detecting, by the circuitry, the emergency alert information; and

retransmitting the emergency alert information obtained in the demodulating to an external device via a communication medium.

Further, a technology according to an embodiment of the present disclosure is a non-transitory computer-readable storage medium storing a computer program which, when executed by a computer, causes the computer to:

receive a transmission of a physical layer frame including emergency alert information;

demodulate the received physical layer frame;

detect the emergency alert information; and

provide an alert based on the emergency alert information obtained through the demodulation.

Further, a technology according to an embodiment of the present disclosure is a non-transitory computer-readable storage medium storing a computer program which, when executed by a computer, causes the computer to:

receive a transmission of a physical layer frame including emergency alert information;

demodulate the physical layer frame;

detect the emergency alert information; and

retransmit the emergency alert information obtained through the demodulation to an external device via a communication medium.

Computer programs according to the embodiment of the present disclosure each define a computer program described in a computer-readable form to realize a predetermined process on a computer. In other words, by installing the computer programs according to the embodiment of the present disclosure, a cooperative operation is performed on the computer and the same operational advantageous effects as those of the reception device according to the embodiment of the present disclosure can be obtained.

A technology according to an embodiment of the present disclosure is an external device, including circuitry configured to:

receive emergency alert information that is retransmitted by a reception device via a communication medium, and

provide an alert based on the emergency alert information received from the reception device, in which

the emergency alert information is included in a physical layer frame of a transmission received by the reception device, and

the reception device demodulates the physical layer frame and detects the emergency alert information before the emergency alert information is retransmitted.

### Advantageous Effects of Invention

According to an embodiment of the present technology disclosed in the present specification, it is possible to provide the excellent reception device and reception method capable of receiving a broadcast signal on which emergency alert information is superimposed and sending out an alert properly, the external device of the reception device, and the computer program.

The reception device to which the present technology disclosed in the present specification is applied can detect the emergency alert information superimposed on the physical layer of the broadcast signal and notifying of an alert quickly.

The reception device to which the present technology disclosed in the present specification is applied has a simple configuration, an activation time is shorter than that of a general television receiver, and power consumption is small at the time of activation. Accordingly, the reception device to which the present technology disclosed in the present specification is applied can notify of an alert quickly even in a standby state or a stop state. Further, even when reception devices in an emergency alert target area detect emergency alert information and are concurrently activated, power to be supplied in the area is not short.

The reception device to which the present technology disclosed in the present specification is applied can retransmit emergency alert information detected from a broadcast signal to an external device via a communication medium such as a home network. Accordingly, residents distant from a location where a reception device such as a television receiver is installed can be quickly notified of the emergency alert via external devices. Further, on the assumption that the external devices are battery-driven devices such as multi-functional portable terminals, even when the external devices in an emergency alert target area are concurrently activated, power to be supplied in the area is not short.

The advantageous effects described in the present specification are merely examples and the advantages of the present technology are not limited thereto. Further, additional advantageous effects can be obtained in some cases in addition to the foregoing advantageous effects of the present technology.

The objects, features, and advantages of the technology disclosed in the present specification will be apparent through more detailed description based on embodiments to be described below and the appended drawings.

### BRIEF DESCRIPTION OF DRAWINGS

FIG. 1 is a diagram schematically illustrating an example of the configuration of an emergency alert information transmission system 1.

FIG. 2 is a diagram schematically illustrating an inner configuration of a transmission device 200.

FIG. 3 is a diagram schematically illustrating a format example of a transmission frame of a broadcast signal 210 in conformity with a predetermined broadcast standard.

FIG. 4 is a diagram illustrating another format example of a transmission frame in which emergency alert information is included in a preamble.

FIG. 5A is a diagram illustrating a syntax example of emergency alert information stored in a reserved bit section 31B.

FIG. 5B is a diagram illustrating a syntax example of the emergency alert information stored in the reserved bit section 31B.

FIG. 5C is a diagram illustrating a syntax example of the emergency alert information stored in the reserved bit section 31B.

FIG. 5D is a diagram illustrating a syntax example of the emergency alert information stored in the reserved bit section 31B.

FIG. 6 is a diagram illustrating definition of each language used in FIGS. 5A to 5D.

FIG. 7 is a diagram illustrating a syntax example of emergency alert information (EWS) stored in an emergency alert information section 411B in a format of a predetermined message mode.

FIG. 8 is a diagram illustrating examples of values and alerts written in an aural_message_type field 512 at the time of the predetermined message mode.

FIG. 9 is a flowchart illustrating a processing order in which the transmission device 200 transmits (broadcasts) emergency alert information to a reception device 300.

FIG. 10 is a diagram schematically illustrating an inner configuration of the reception device 300 according to an embodiment of the present technology—described in the present specification.

FIG. 11 is diagram illustrating a time chart in which the reception device 300 illustrated in FIG. 10 receives a transmission frame transmitted from the transmission device 200 and sends out an emergency alert.

FIG. 12 is a diagram schematically illustrating an inner configuration of the reception device 300 according to another embodiment of the present technology—described in the present specification.

FIG. 13 is a diagram illustrating a time chart in which the reception device 300 illustrated in FIG. 12 retransmits emergency alert information included in the transmission frame received from the transmission device 200 and sends out an emergency alert by external devices 350.

### DESCRIPTION OF EMBODIMENTS

Hereinafter, embodiments of the present technology disclosed in the present specification will be described in detail with reference to the drawings.

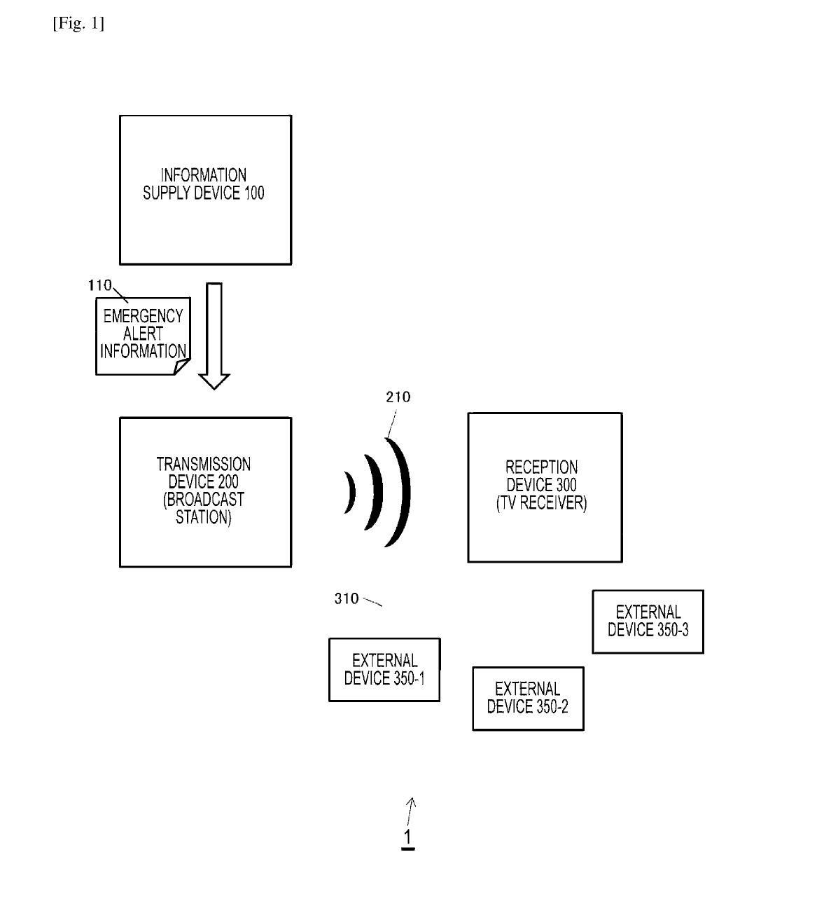

FIG. 1 is a diagram schematically illustrating an example of the configuration of an emergency alert information transmission system 1. The illustrated emergency alert information transmission system 1 includes an information supply device 100 which supplies emergency alert information, a transmission device 200 that transmits the supplied emergency alert information 110, a reception device 300 that receives the emergency alert information and notifies residents of the emergency alert information, and one or more external devices 350-1, 350-2, that are connected to the reception device 300 via a home network 310 or the like.

For example, a government agency such as the meteorological agency or other disaster information management agencies operates the information supply device 100 as a sender, and the information supply device 100 supplies the transmission device 200 with emergency alert information 110 for warning that a variety of emergencies occur, such as natural disasters such as earthquake and tsunami caused by earthquake, typhoon or heavy rain, windstorm, tornado, flood,and mountain fire, large-scale terrorism, travelling situations of transportations, and school information.

A communication path connecting the information supply device 100 to the transmission device 200 has any configuration. For example, a public network such as the Internet or a dedicated line can be used as the communication path. Alternatively, emergency alert information written on a sheet medium may be transmitted to a user (a person responsible for a broadcast station or the like) of the transmission device 200 using a facsimile or the like.

Any format of description of the emergency alert information 110 can be used. For example, the emergency alert information 110 may be described in a format of a structure description language such as XML (eXtensible Markup Language). For example, United States Department of Homeland Security, United States Geological Survey (USGS), and many organizations such as the government of Canada exchange information regarding a wide variety of warnings or emergency alerts using a simple and standardized XML data format called the CAP (Common Alerting Protocol). Additionally, messages with the CAP format can include not only text information but also rich media such as HTML (Hyper Text Transfer Protocol), JPEG (Joint Photographic Experts Group), and MPEG (Moving Picture Experts Group) 4-video. The information supply device 100 may supply the emergency alert information 110 with the CAP format to the transmission device 200.

The transmission device 200 broadcasts, for example, a broadcast signal 210 operated by a broadcast station performing a terrestrial digital broadcast service and formatted in conformity with a standard of a television program or the like. In FIG. 1, only one transmission device 200 is illustrated for simplicity, but it is noted that the transmission device 200 is installed in each broadcast station. In the embodiment, the transmission device 200 inserts emergency alert information with a format to be described below into the broadcast signal 210 transmitting moving-image content such as a television program and broadcasts the broadcast signal 210.

In FIG. 1, the transmission device 200 is configured to receive the emergency alert information 110 from the information supply device 100 operated by a government agency, but the transmission device 200 may be configured to acquire emergency alert information from an information source other than the information supply device 100. Further, the information supply device 100 may not necessarily be operated by a government agency and may be operated by a private institution or a broadcast station itself.

The reception device 300 has a tuner receiving the terrestrial digital broadcast signal 210 therein. When the reception device 300 detects the emergency alert information inserted with the format to be described below from the received broadcast signal, the reception device 300 notifies residents of an emergency alert quickly through audio, display of a text, blink of an LED, or the like. The reception device 300 retransmits the detected emergency alert information to the external devices 350-1, 350-2, in the home network 310. As will be described below, the reception device 300 may have a simple-configuration in which the physical layer of the broadcast signal can be demodulated. Of course, the reception device 300 may be configured to be included in a television receiver or a set-top box. The plurality of reception devices 300 such as television receivers or set-top boxes are assumed to be installed in each general home. However, in FIG. 1, only one reception device 300 is illustrated for simplicity.

The external devices 350-1, 350-2, are devices scattered in homes, such as multi-functional terminals such as smartphones, Blu-ray disc players, and various CEs (Consumer Electronics) devices and are connected to the reception device 300 via the home network 310. For example, the home network 310 is constructed using a technology such as Ethernet (registered trademark), Wi-Fi (Wireless Fidelity) (registered trademark), DLNA (Digital Living Network Alliance), or Bluetooth (registered trademark). In the embodiment, the external devices 350 send out the emergency alert aurally or visually based on the emergency alert information retransmitted from the reception device 300. The details thereof will be described below.

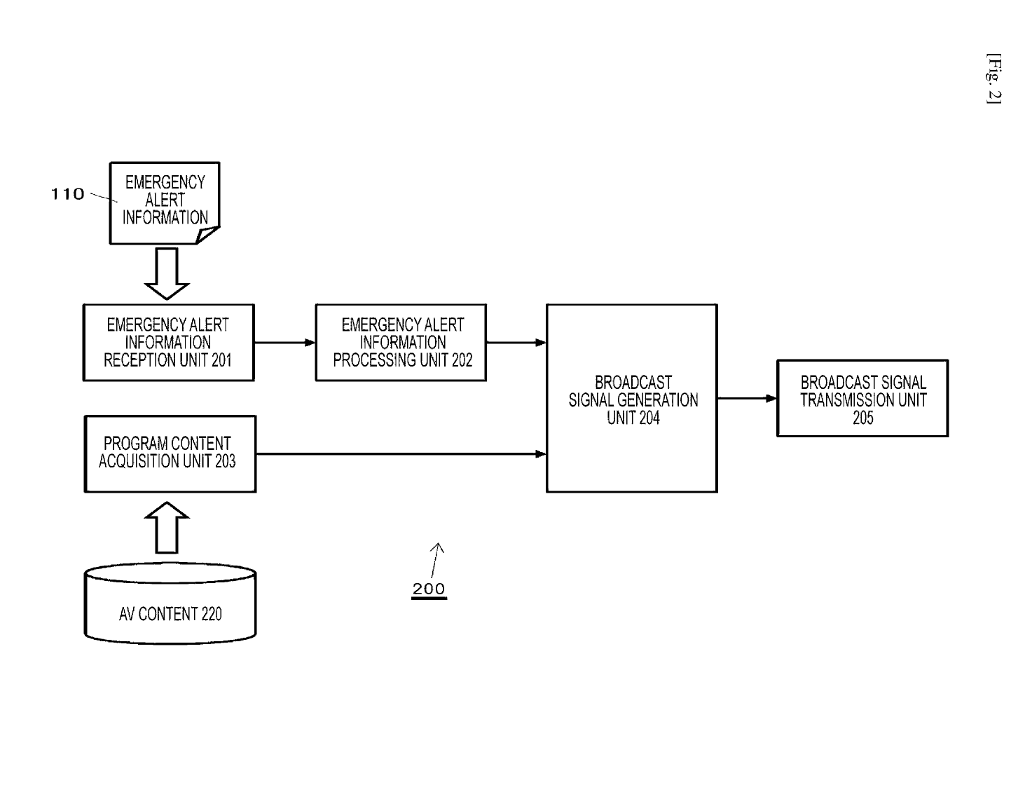

FIG. 2 is a diagram schematically illustrating an inner configuration of the transmission device 200. The illustrated transmission device 200 includes an emergency alert information reception unit 201, an emergency alert information-processing unit 202, a program content acquisition unit 203, a broadcast signal-generation unit 204, and a broadcast signal transmission unit 205.

The emergency alert information reception unit 201 receives the emergency alert information 110 described in the CAP format or any other format from the information supply device 100 via a communication path such as a public network such as the Internet, or a dedicated line (none of which is illustrated).

The emergency alert information processing unit 202 performs a process such as a filtering process of removing unnecessary information (for example, information unrelated to a broadcast area) or a file format conversion process on the received emergency alert information 110. In the embodiment, when the transmission device 200 transmits the emergency alert information to the reception device 300, a plurality of formats are prepared (which will be described later). The emergency alert information processing unit 202 determines a format with which the emergency alert information is transmitted. For example, the emergency alert information processing unit 202 may determine a transmission format by analyzing the content of the emergency alert information or may determine a transmission format according to a manual operation (a guideline in a broadcast station) of a user (an editor or the like of a broadcast program).

The program content acquisition unit 203 acquires AV content which is a broadcast program main body or data to be supplied as data broadcast. The program content acquisition unit 203 takes out corresponding AV content from a storage site in which the AV content is already recorded according to a broadcast time in some cases and supplies live AV content from a studio or a location site in some cases.

The broadcast signal generation unit 204 generates a broadcast signal with a format in conformity with a predetermined broadcast standard. As a broadcast standard, ATSC (Advanced Television Systems Committee) adopted in the United States of America, Canada, Mexico, Korea, and the like can be exemplified. In the embodiment, the broadcast signal includes a preamble which is used to tune a broadcast channel on a reception side and a payload which is a program main body, stores AV content, and has a fixed length or a variable length. In the embodiment, the broadcast signal generation unit 204 stores the emergency alert information with the format determined by the emergency alert information processing unit 202 in the preamble. The details thereof will be described below.

The broadcast signal transmission unit 205 performs encoding, digital modulation such as OFDM (Orthogonal Frequency Division Multiplexing), AD conversion, upconversion to an RF band (a frequency channel assigned to the broadcast station), and power amplification on the broadcast signal generated by the broadcast signal generation unit 204, and then the broadcast signal is transmitted from a transmission antenna (not illustrated) such as a radio tower.

All of the functional modules 201 to 205 may not be necessarily be wired physically in a single device and at least some of the functional modules can be configured as a device physically independent from the other functional modules. For example, the emergency alert information processing unit 202 may be configured as an emergency alert information processing server on the Internet (not illustrated).

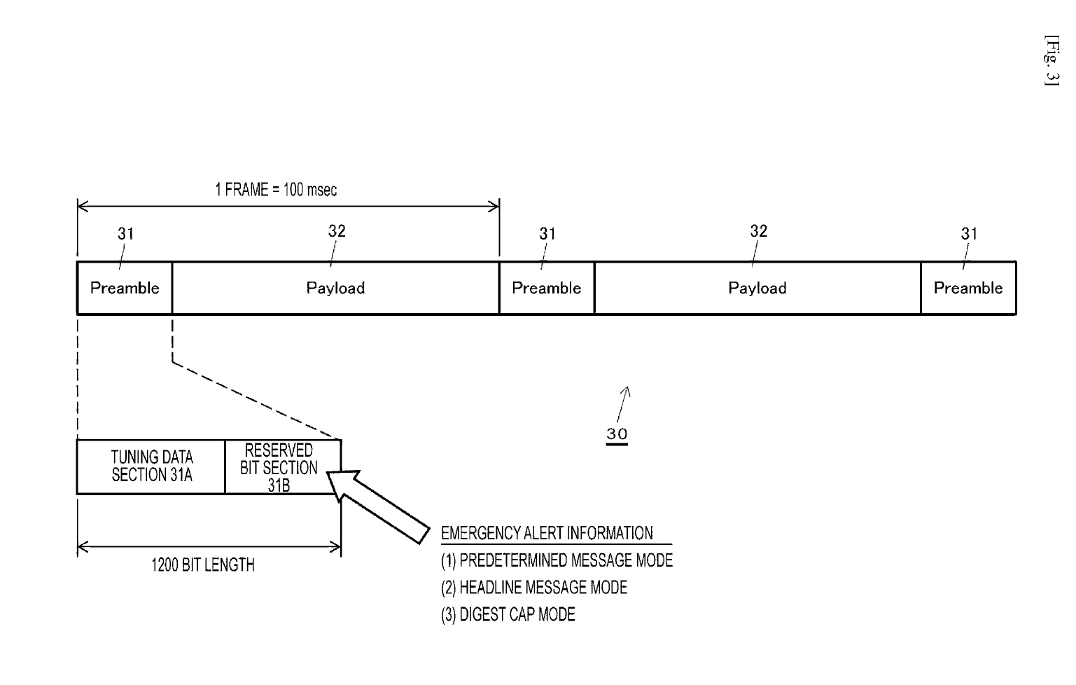

FIG. 3 is a diagram schematically illustrating a format example of a transmission frame of the broadcast signal in conformity with a predetermined broadcast standard. In the illustrated example, a transmission frame 30 includes a preamble section 31 which is used to tune a broadcast channel on a reception side and a payload 32 which is a program main body, stores AV content and auxiliary data, and has a fixed length. One frame of the transmission frame 30 is diverse according to a transmission scheme. In the embodiment, for example, one frame is set to 100 milliseconds.

The preamble section 31 includes a tuning data section 31A and a reserved bit section 31B. A total bit length of the preamble section 31 is diverse according to a transmission scheme. In the embodiment, for example, the total bit length of the preamble section 31 is set to 1200 bit length. The tuning data section 31A stores L1 data which is data (Critical data for tuning) for tuning a broadcast channel on the reception side. In the embodiment, the reserved bit section 31B in the preamble section 31 stores the emergency alert information processed by the emergency alert information processing unit 202. Since the transmission frame is set to 100 milliseconds, the emergency alert information reaches the reception side at intervals of 100 milliseconds.

Since the emergency alert information is stored not in the payload 32 but in the preamble section 31, it should be fully understood to be different from the ISDB-T scheme of transmitting emergency alert information as a control packet (PMT) in a TS (Transport Stream). Further, it should be fully understood that the emergency alert information is configured to be superimposed on the physical layer of the transmission frame and the emergency alert information can be taken out through a demodulation process at the physical layer level on the reception side.

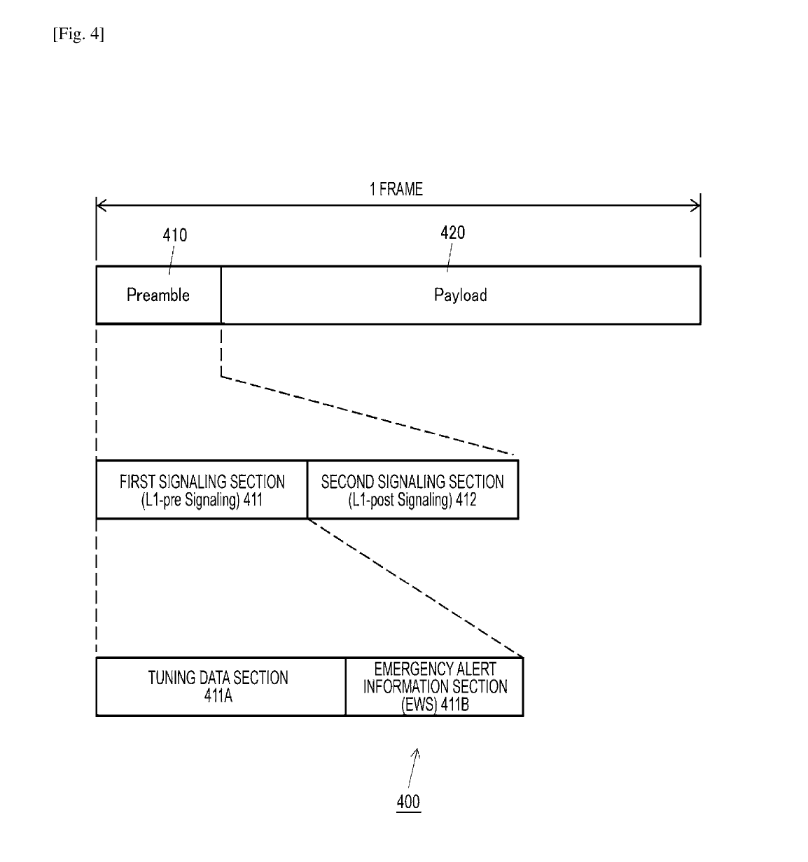

FIG. 4 is a diagram illustrating another format example of the transmission frame including the emergency alert information in the preamble. The illustrated transmission frame 400 includes a preamble section 410 and a payload 420. The preamble section 410 includes a plurality of signaling sections. In the illustrated example, the preamble section 410 is assumed to include a first signaling section (L1-pre Signaling) 411 and a second signaling section (L1-post Signaling) 412.

When the preamble section includes the plurality of signaling sections, an error correction code (ECC) or a phase modulation scheme may be switched for each signaling section. Among the signaling sections, the first signaling section 411 includes a tuning data section 411A which is used to tune a broadcast channel on the reception side and an emergency alert information section (EWS) 411B. The emergency alert information section 411B stores the emergency alert information processed by the emergency alert information processing unit 202.

Since the emergency alert information is stored in the first signaling section 411, it should be fully understood to be different from the ISDB-T scheme of transmitting emergency alert information as a control packet (PMT) in a TS (Transport Stream). Further, as in FIG. 3, it should be fully understood that the emergency alert information is configured to be superimposed on the physical layer of the transmission frame and the emergency alert information can be taken out through a demodulation process at the physical layer level on the reception side.

In the embodiment, three formats to be described below are prepared as formats for transmitting the emergency alert information.
(1) Predetermined Message Mode
(2) Headline Message Mode
(3) Digest CAP Mode

The predetermined message mode is a format in which the emergency alert information in which a message is predetermined in advance is expressed in a binary format with a small size and is transmitted only with one frame (that is, one preamble). Situations desired to be alerted urgently are diverse, for example, natural disasters such as earthquake and tsunami caused by earthquake, typhoon or heavy rain, windstorm, tornado, and flood, large-scale terrorism, traveling situations of transportations, and school information. The emergency alert information can be stored in one preamble by replacing a definite message for reporting each situation with index information of a small size expressed in a predefined binary format. For example, an index number of the binary format is assigned to a situation desired to be reported and only the index number is stored in the reserved bit section 31B or the emergency alert information section (EWS) 411B of the preamble. The reception side can retrieve the original emergency alert information from index numbers decoded from anyone of the preambles reached at the 100-millisecond period and instantly send out the alert. Since only the preamble section 31 may be decoded and it is not necessary to decode the payload 32, a definite message can be sent out instantly with low load (only by a process on the physical layer or a lower layer of a communication protocol).

The headline message mode is a format in which the emergency alert information is configured as headline text information described in a text form and one piece of emergency alert information is transmitted using 10 to 20 frames. Since the emergency alert information is not encoded in a binary format but is described as a text, the emergency alert information becomes expressive. Accordingly, the reception side can supply the emergency alert information of more detailed content than a definite message. Since only the preamble may be decoded and it is not necessary to decode payload, a message of the emergency alert can be sent out with low load (only by a process on the physical layer or a lower layer of a communication protocol). However, until 10 to 20 frames are received, the alert may not be sent out. Therefore, the headline message mode lacks in instantaneousness compared to the predetermined message mode.

The digest CAP mode is a format in which the emergency alert information with the CAP format supplied from the information supply device 100 is transmitted after digest processing such as filtering or file format conversion is performed. Even after the digest processing is performed, the emergency alert information with the CAP format has a large size and one piece of emergency alert information is transmitted using the number of frames greater than 20 frames. The more detailed emergency alert information than headline text information can be supplied. However, a processing time from transmission start of the emergency alert information to the sending of the alert from the reception side is longer than in the headline message mode.

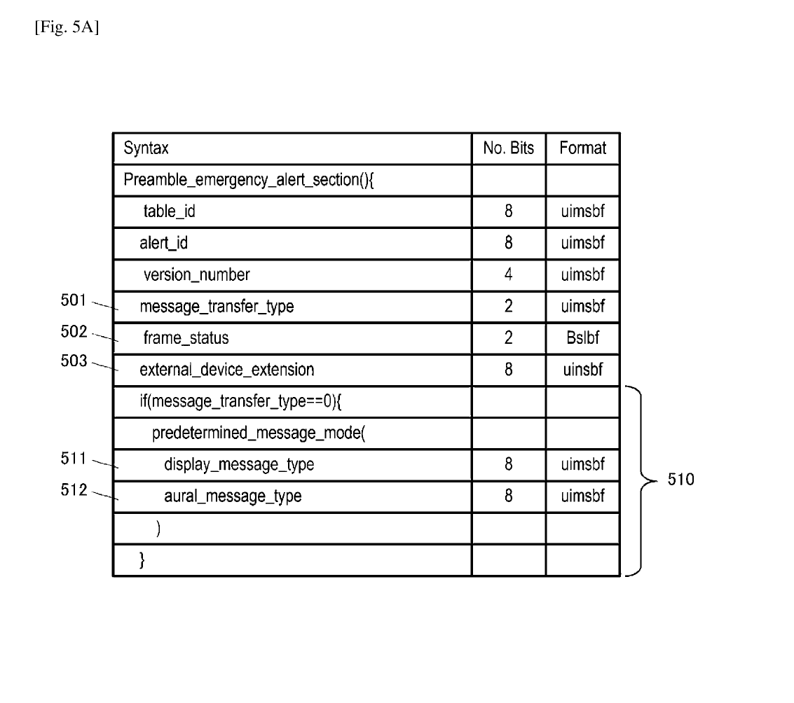

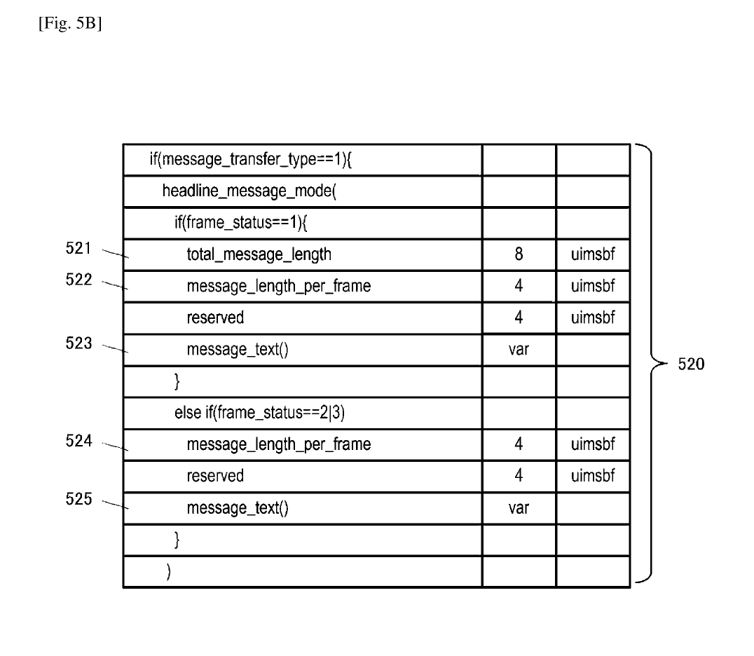

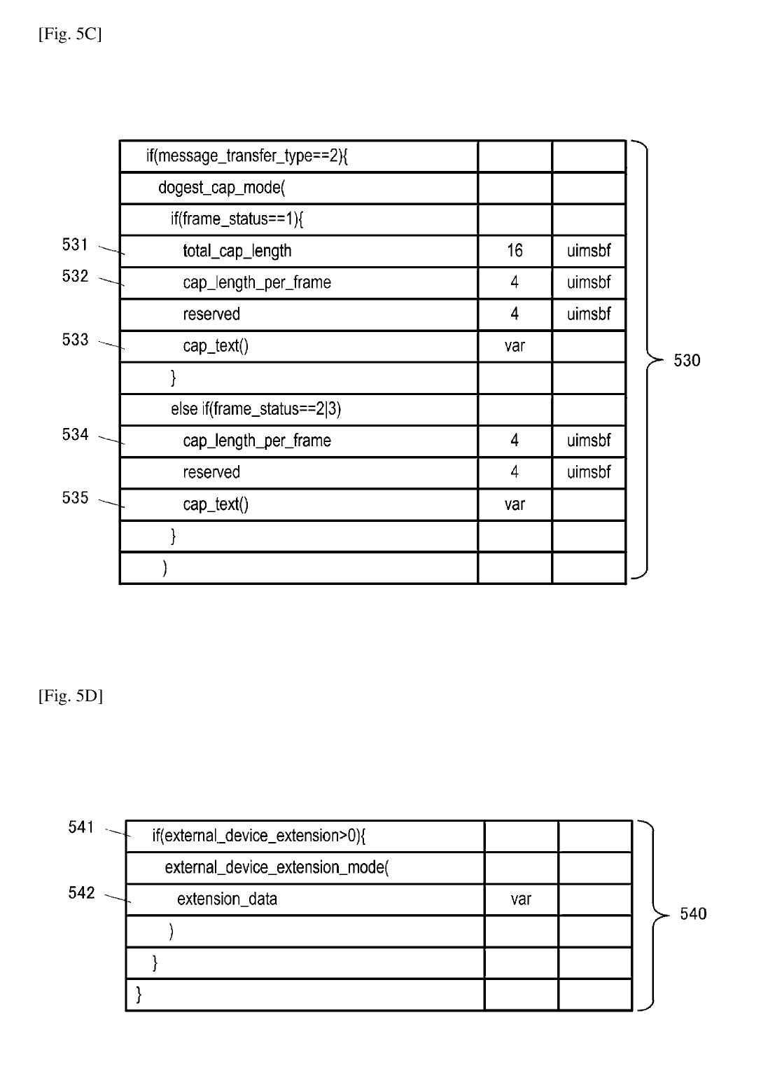

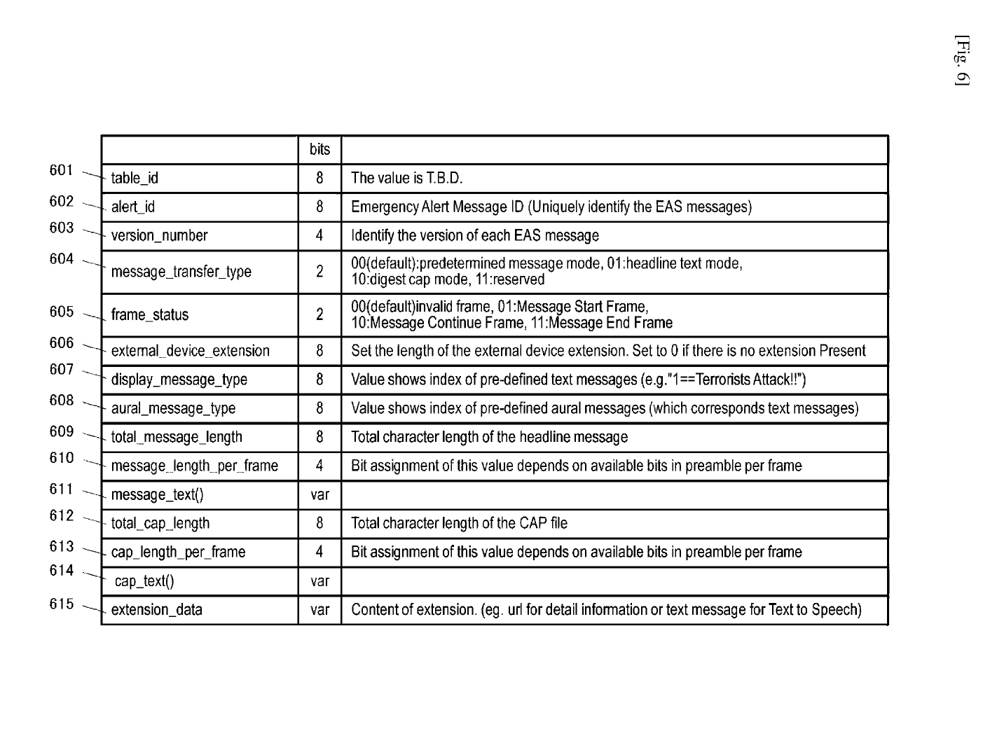

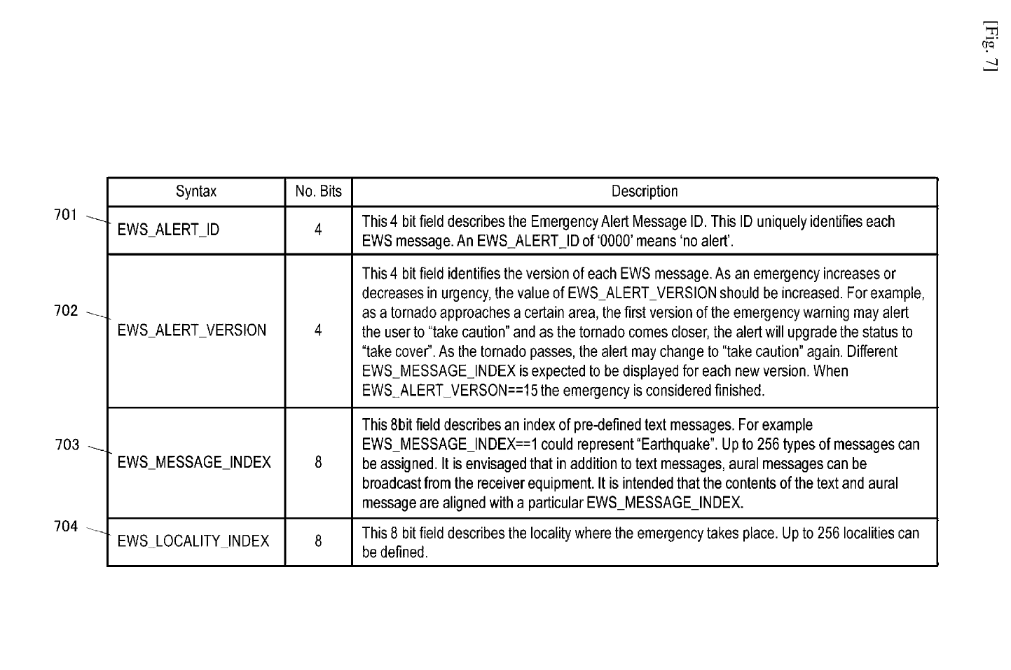

FIGS. 5A to 5D are diagrams illustrating a syntax example of the emergency alert information stored in the reserved bit section 31B. FIG. 6 is a diagram illustrating definition of each language used in FIGS. 5A to 5D.

First, the definition of each language will be described with reference to FIG. 6 in order from the upper side.

Reference numeral 601 denotes Table_id which has an 8-bit value decided under future discussion. Reference numeral 602 denotes alert_id which has an 8-bit value and indicates identification information of the emergency alert information and uniquely identifies an EAS (Emergency Alert System) message. Reference numeral 603 denotes version number which has a 4-bit value and indicates identification information of a version of each EAS message.

Reference numeral 604 denotes message_transfer_type which has a 2-bit value and indicates a format in which the emergency alert information is transmitted, 00 (default value) represents the predetermined message mode, 01 represents the-headline text mode, 10 represents the digest CAP mode, and 11 represents a reserved value.

Reference numeral 605 denotes frame_status which has a 2-bit value and indicates the state of the transmission frame, 00 (default value) represents an invalid frame, 01 represents a start frame of an emergency alert information message, 10 represents a halfway frame of the emergency alert information message, and 11 represents an end frame of the emergency alert information message.

Reference numeral 606 denotes external_device_extension which has a value with an 8-bit length and indicates the data length of extension information destined for the external device 350 (external device). Here, “external_device_extension=0” indicates that extension information dedicated for the external device 350 is not present.

Reference numeral 607 denotes display_message_type which has an 8-bit value and indicates an index of a pre-defined text message (for example, a message is defined in advance, such as “1 representing Terrorists Attack!”). Reference numeral 608 denotes aural_message_type which has an 8-bit value and indicates an index of a pre-determined aural message and corresponds to the pre-defined text message. Reference numeral 609 denotes total_message_length which has an 8-bit value and indicates a total character length of a headline text message.

Reference numeral 610 denotes message_length_per_frame which has a 4-bit value and indicates a character length of a message for each frame, and bit assignment of this value depends on the number of bits available in the preamble of each frame. Reference numeral 611 denotes message_text( ) which indicates a variable into which a text of the headline text message is substituted.

Reference numeral 612 denotes total_cap_length which has an 8-bit value and indicates a total character length of a cap file. Reference numeral 613 denotes cap_length_per_frame which has a 4-bit value and indicates a character length by which data in the cap file is stored for each frame and bit assignment of this value depends on the number of bits available in the preamble for each frame. Reference numeral 614 denotes cap_text( ) which indicates a variable into which a text in the cap file is substituted.

Reference numeral 615 denotes extension_data which indicates a variable into which content of the extension information dedicated for the external device 350 is substituted. For example, a text message for url (uniform resource locator) of a location suggesting detailed information regarding an emergency alert or text reading (Text to Speech) by audio synthesis is written on extension_data. Further, when url is written, abbreviated url used on the Internet is preferably used in order to restrict an amount of information which can be transmitted in the preamble section of the transmission frame.

Subsequently, the syntax of the emergency alert information will be described with reference to FIGS. 5A to 5D.

Reference numeral 501 denotes a message_transfer_type field of a 2-bit length indicating which format is used to transmit the emergency alert information among the predetermined message mode, the headline message mode, and the digest CAP mode in the preamble of the frame. Reference numeral 502 denotes a frame_status field of a 2-bit length indicating a position to which the frame corresponds among a start position (Start), a halfway position (Continue), and an end position (End) of the emergency alert message. Reference numeral 503 denotes an external_device_extension field of an 8-bit length indicating the data length of the extension information destined for the external device 350 (external device). When 0 is substituted into the external_device_extension field, it is indicated that the extension information dedicated for the external device 350 is not present (as described above).

Reference numeral 510 denotes a part of a syntax in the case of the predetermined message mode (where message_transfer_type is 0). In this case, as denoted by reference numeral 511, a message format (display_message_type) of a message displayed as the emergency alert information on a screen is described with 8 bits. Further, as denoted by reference numeral 512, a message format (aural_message_type) of a message aurally output by text reading (Text to Speech) is described with 8 bits.

Reference numeral 520 denotes a part of a syntax in the case of the headline message mode. In this case, in a start frame (where frame_status is 1) of the message, a total data length (total_message_length) of a headline message to be transmitted is described with 8 bits, as denoted by reference numeral 521, a data length (message_length_per_frame) of a message stored in the frame is described with 4 bits, as denoted by reference numeral 522, and a message text (message_text) is described, as denoted by reference numeral 523. Further, in half way and end frames (where frame_status is 2 or 3) of the message, a data length (message_length_per_frame) of the message stored in the frame is described with 4 bits, as denoted by reference numeral 524, and a message text (message_text) is described, as denoted by reference numeral 525.

Reference numeral 530 denotes a part of a syntax in the case of the digest CAP mode. In this case, in a start frame (where frame_status is 1) of the message, a total data length (total_message_length) of a headline message to be transmitted is described with 16 bits, as denoted by reference numeral 531, a data length (cap_length_per_frame) of a cap file stored in the frame is described with 4 bits, as denoted by reference numeral 532, and a text (cap_text) of the content of the cap file is described, as denoted by reference numeral 533. Further, in half way and end frames (where frame_status is 2 or 3) of the message, a data length (cap_length_per_frame) of the cap file stored in the frame is described with 4 bits, as denoted by reference numeral 534, and a text (cap_text) of the content of the cap file is described, as denoted by reference numeral 535.

Reference numeral 540 denotes a part of the syntax of the extension information-destined for the external device 350 (external deice). When the extension information is present, external_device_extension retains the data length of the extension information. When the extension information is not present, external_device_extension retains 0. As denoted by reference numeral 541, when external_device_extension is a positive value, the message is in external_device_extension_mode (external device extension mode) and the content of the extension information dedicated for the external device 350 is-substituted to extension_data denoted by reference numeral 542. For example, url of a location suggesting detailed information regarding an emergency alert or a text message for text reading (Text to Speech) by audio synthesis is written on extension_data.

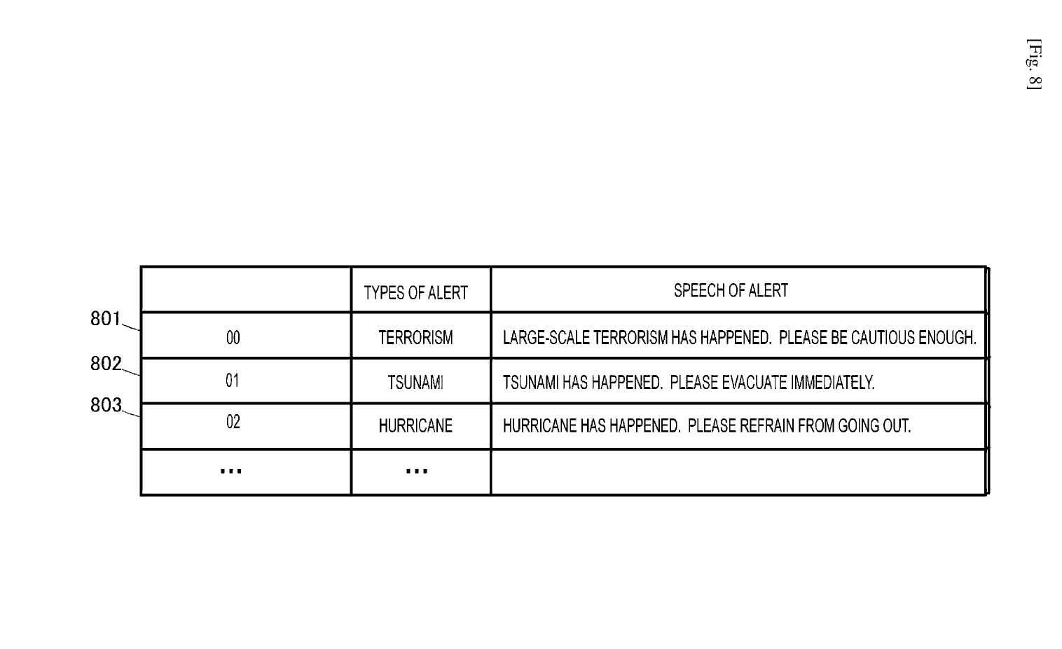

FIG. 7 is a diagram illustrating a syntax example of the emergency alert information (EWS) stored in the emergency alert information section 411B in the format of the pre-determined message mode.

Reference numeral 701 denotes EWS_ALERT_ID indicating a field that describes emergence alert message identification information. The identification information uniquely identifies each emergency alert message. EWS_ALERT_ID of ‘0000’ means “no alert.”

Reference numeral 702 denotes EWS_ALERT_VERSION indicating a field identifying a version of the emergency alert message. As an emergency increases or—decreases in urgency, it is necessary to increase the value of EWS_ALERT_VERSION. For example, as a tornado approaches a certain area, a first version of the emergency alert alerts the residents to “take caution”. When the tornado comes closer, the alert upgrades the state to “take cover.” As the tornado passes, the alert is changed to “take caution” again. Different EWS_MESSAGE_INDEX is expected to be displayed for each new version. When the value of EWS_ALERT_VERSION is 15, the emergency is considered finished.

Reference numeral 703 denotes EWS_MESSAGE_INDEX indicating a field that—describes an index of the pre-defined text message. For example, when the value of EWS_MESSAGE_INDEX is 1, the value represents the pre-defined text message called “Earthquake.” EWS_MESSAGE_INDEX can be assigned to up to 256 types of messages. It is envisaged that in addition to text messages, aural messages are broadcast from the reception device 300. It is intended that the contents of the text and the aural message are aligned with particular EWS_MESSAGE_INDEX.

Reference numeral 704 denotes EWS_LOCALITY_INDEX indicating a field that—describes locality where an emergency takes place. EWS_LOCALITY_INDEX can be defined in up to 256 localities.

FIG. 8 is a diagram illustrating examples of values and alerts written in the aural_message_type field 512 at the time of the predetermined message mode.

Reference numeral 801 denotes aural_message_type=00 indicating that the type of alert is “terrorism.” In this case, the reception side performs text reading (Text to Speech) by audio synthesis or display of a text message “Large-scale terrorism has happened. Please be cautious enough.”

Reference numeral 802 denotes aural_message_type=01 indicating that the type of alert is “tsunami.” In this case, the reception side performs text reading (Text to Speech) by audio synthesis or display of a text message “Tsunami has happened. Please evacuate immediately.”

Reference numeral 803 denotes aural_message_type=02 indicating that the type of alert is “hurricane.” In this case, the reception side performs text reading (Text to Speech) by audio synthesis or display of a text message “Hurricane has happened. Please refrain from going out.”

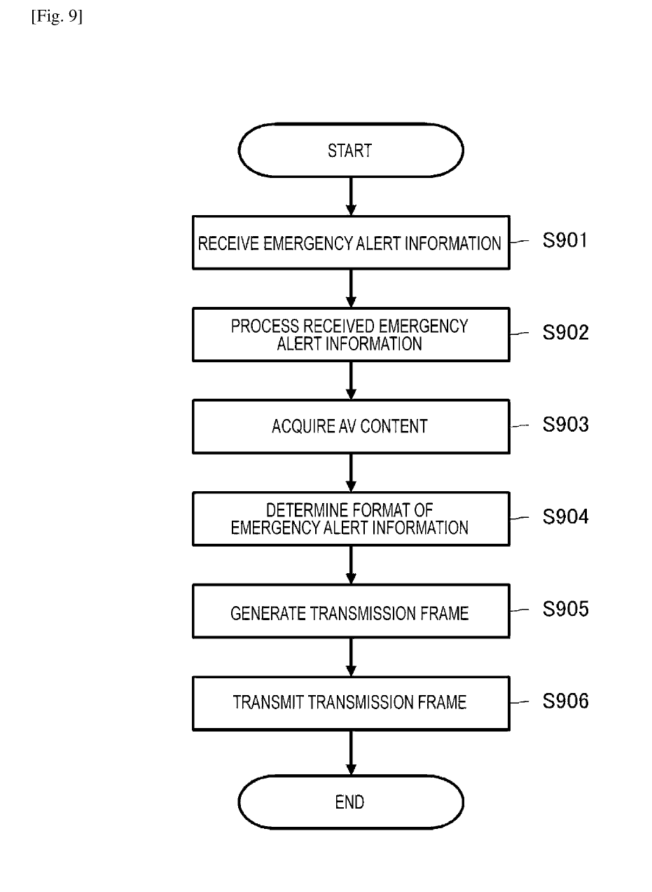

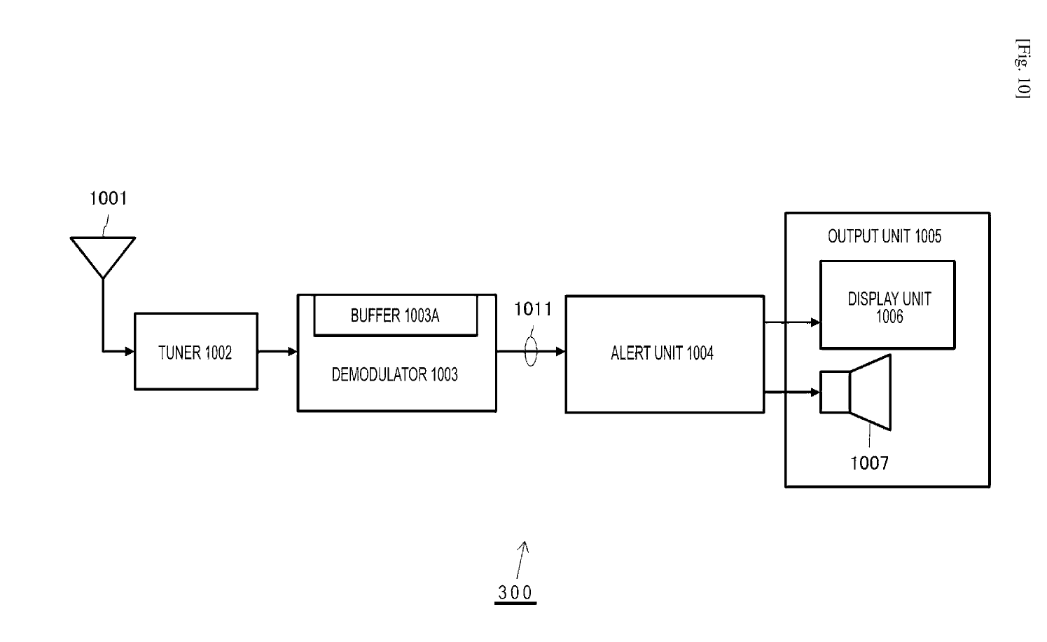

FIG. 9 is a flowchart illustrating a processing order in which the transmission device 200 transmits (broadcasts) the emergency alert information to the reception device 300.

First, the emergency alert information reception unit 201 receives the emergency alert information 110 described in the CAP file format or any other data format from the information supply device 100 via a communication path such as a public network such as the Internet or a dedicated line (step S901).

Subsequently, the emergency alert information processing unit 202 performs a process such as a filtering process of removing unnecessary information (for example, information unrelated to a broadcast area) or a file format conversion process on the received emergency alert information 110 (step S902).

The program content acquisition unit 203 acquires AV content which is a broadcast program main body (step S903).

Subsequently, the emergency alert information processing unit 202 determines one of the above-described formats (1) to (3) to transmit the emergency alert information to the reception device 300 and generates the emergency alert information according to the determined format (step S904).

Subsequently, the broadcast signal generation unit 204 generates the transmission frame including the preamble used to tune the broadcast channel on the reception side and the payload which is a program main body, stores the AV content, and has a fixed length or a variable length (step S905). At this time,the broadcast signal generation unit 204 superimposes the emergency alert information on the physical layer of the transmission frame (for example, stores the emergency alert information in the preamble, as described above).

Then, the broadcast signal transmission unit 205 performs digital modulation, AD conversion, up conversion to an RF band, power amplification, and the like on the generated transmission frame and outputs the transmission frame from a transmission antenna such as a television tower (step S906).

As illustrated in FIG. 3 or 4, the signal of the emergency alert information is superimposed on the physical signal of the broadcast waves transmitted from the transmission device 200 such as a broadcast station. On the other hand, when the reception device 300 is configured by a television receiver, the received emergency alert information may not be displayed on a screen as long as the entire television receiver is not activated. An activation time of the television receiver is normally about several ten seconds. In particular, in the case of high urgent alert information, an activation standby time may be fatal when evacuation from tsunami is necessary.

When the television receiver is activated, large power is consumed. When the television receivers in an alert target area start to be concurrently activated in response to reception of the broadcast signal on which the emergency alert information is superimposed, there is a concern that a power failure occurs due to a large influence on power supply to the area.

Accordingly, according to an embodiment of the present technology disclosed in the present specification, the reception device 300 is configured to include a tuner that tunes and receives a broadcast signal, a demodulator that demodulates a physical layer level of the broadcast signal, and an alert device that sends out an alert of audio, text display, or the like corresponding to the emergency alert information (see FIGS. 3 and 4) superimposed on the physical layer of the broadcast signal. Since an activation time is short in the reception device 300 with such a simple configuration, an alert can be sent out immediately even from a standby state when the broadcast signal on which the emergency alert information is superimposed is received. Power consumption is also small in the reception device 300 with such a simple configuration. Thus, even when all of the reception devices 300 in an area where an emergency alert is sent out are concurrently activated, power to be supplied to the area is not short.

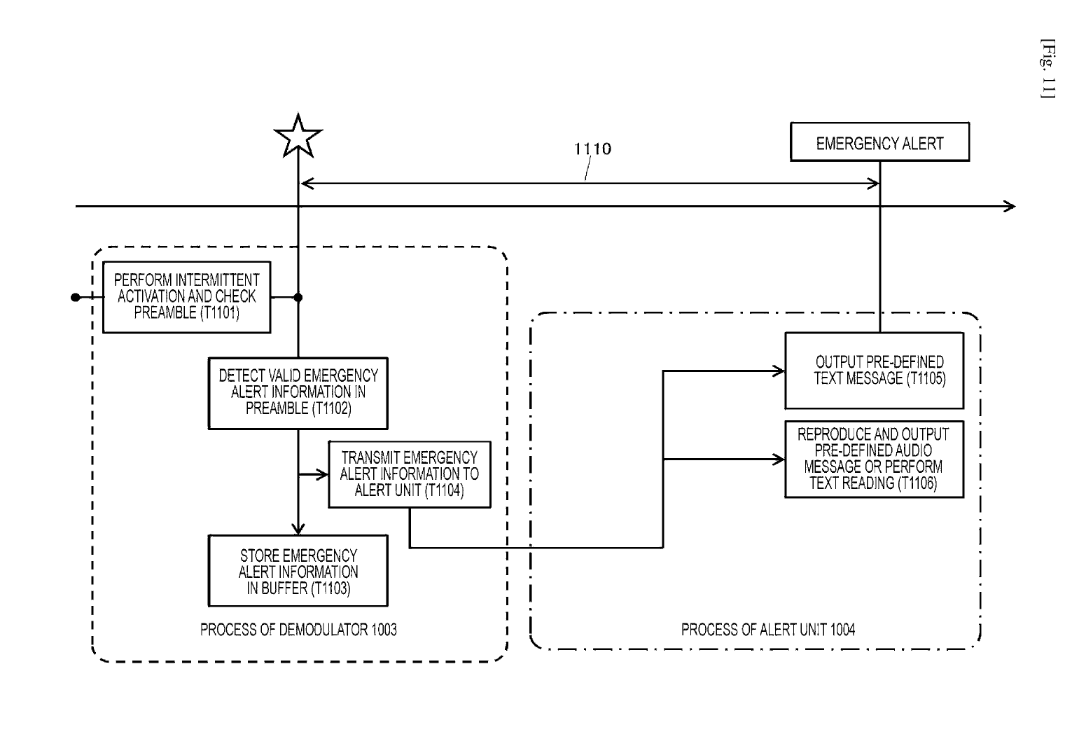

FIG. 10 is a diagram schematically illustrating an inner configuration of the reception device 300 according to an embodiment of the present technology disclosed in the present specification. The illustrated reception device 300 includes an antenna 1001 that receives a broadcast signal, a tuner 1002, a demodulator 1003, an alert unit 1004, and an output unit 1005. The reception device 300 has a simple configuration, and may be a simple broadcast receiver dedicated for an emergency alert or may be embedded in a general television receiver.

The tuner 1002 tunes a component of a predetermined frequency channel from a broadcast signal received by the antenna 1001.

The demodulator 1003 performs a demodulation process on the tuned broadcast signal. In the embodiment, when the demodulator 1003 performs the demodulation process on the preamble section 31 in the transmission frame 30 (or the preamble section 410 in the transmission frame 400) and detects the valid emergency alert information in the preamble section 31 (or the preamble section 410 in the transmission frame 400), the demodulator 1003 outputs the emergency alert information to the alert unit 1004. The demodulator 1003 includes a buffer 1003A that temporarily retains the detected emergency alert information. The demodulator 1003 may not constantly perform the demodulation process to detect the preamble section 31 (or the preamble section 410) and may be intermittently activated to detect the preamble section for power saving.

The demodulator 1003 controls the alert unit 1004 connected via a control bus 1011 configured by a serial interface such as an I²C (Inter-Integrated Circuit). The alert unit 1004 causes the output unit 1005 to send out an alert according to content of the demodulated emergency alert information in response to an instruction from the demodulator 1003. The output unit 1005 includes, for example, a simple device such as the display unit 1006, formed by a display capable of displaying text or a blinking LED (Light Emitting Diode), or a speaker 1007.

The reception device 300 can be configured to correspond to the emergency alert information transmitted in any format of the predetermined message mode, the headline message mode, and the digest CAP mode described above. However, by being correspondable to only the predetermined message mode, the configuration can be further simplified, the activation time can be shortened, and thus low power consumption can be realized.

For example, when the emergency alert information of the predetermined message mode is received, the demodulator 1003 controls an alert to be sent out from the alert unit 1004 according to the type of emergency alert signal such as display_message_type 511 and aural_message_type 512.

The alert unit 1004 stores, for example, a plurality of audio files and thus reproduces audio selected according to the type of received emergency alert signal from the speaker 1007. The audio according to the type of emergency alert signal is exemplified in FIG. 8. When the type of alert is “terrorism,” the alert unit 1004 selects an audio file “Large-scale terrorism has happened. Please be cautious enough.” and reproduces and output the audio file. When the type of alert is “tsunami,” the alert unit 1004 selects an audio file “Tsunami has happened. Please evacuate immediately.” and reproduces and outputs the audio file. When the type of alert is “hurricane,” the alert unit 1004 selects an audio file “Hurricane has happened. Please refrain from going out.”, and reproduces and outputs the audio file.

Of course, the alert unit 1004 can also visually notify hearing-impaired people of the emergency alert rather than an alert by audio by causing the display unit 1006 to notify the residents of the content of the same alert by text-displaying or LED-blinking.

The reception device 300 illustrated in FIG. 10 can inform an alert quickly by audio or the like based on the emergency alert information superimposed on the physical layer of the received broadcast signal. When the reception device 300 is embedded in a general television receiver, an alert can be sent out even during the activation of the television receiver. Even when the television receiver stops or stands by, only the reception device 300 can be activated and an alert can be reported quickly and with low power consumption.

FIG. 11 is diagram illustrating a time chart in which the reception device 300 illustrated in FIG. 10 receives a transmission frame transmitted from the transmission device 200 and sends out an emergency alert.

The demodulator 1003 is intermittently activated and checks data of the preamble section 31 of the transmission frame 30 (or the preamble section 410 of the transmission frame 400) received by the antenna 1001 (T1101).

Then, when the demodulator 1003 detects the valid emergency alert information in the preamble section 31 (or the preamble section 410) (T1102), the demodulator 1003 stores the emergency alert information in the buffer 1003A (T1103), transmits the emergency alert information to the alert unit 1004 via the I²C interface 1101, and instructs the alert unit 1004 to generate an alert (T1104). The emergency alert information transmitted from the demodulator 1003 to the alert unit 1004 includes display_message_type and aural_message_type (see FIG. 5A) described in the emergency alert information transmitted in the format of the predetermined message mode and extension_data (see FIG. 5D) described in the emergency alert information in the external device extension mode.

Then, the alert unit 1004 outputs the pre-defined text message by reading (Text to Speech) by audio output from the speaker 1007 or by display output from the display unit 1006 (T1105).

The alert unit 1004 reproduces and outputs the pre-defined audio message for aural_message_type transmitted from the demodulator 1003 (T1106). Alternatively, the alert unit 1004 performs reading (Text to Speech) of the text message—transmitted as extension_data.

In FIG. 11, a section denoted by reference numeral 1110 is a necessary time in which the transmission frame reaches the reception device 300 and then the message of the emergency alert information is sent out. In the illustrated example, the message of the emergency alert information can be output in a short time through only the process on the physical layer of the transmission frame by the demodulator 1003. For example, when the emergency alert information is transmitted in the predetermined message mode, it is not necessary to perform an advanced process such as analysis of the text information or the CAP data. It is enough for a simple processing function module of the demodulator 1003 to operate and the necessary time 1110 can be further shortened.

In the foregoing embodiment, the reception device 300 receiving the broadcast signal can send out the emergency alert. In this case, although the reception device 300 is configured by a television receiver or is configured by a simple broadcast receiver which can process the broadcast signal up to a physical layer level, the residents are assumed to be located near the reception device 300. There is a concern that the residents distant from a location where the reception device 300 is installed may not be aware of the emergency alert and too late to escape.

Accordingly, in another embodiment of the technology disclosed in the present specification, the reception device 300 receiving a broadcast signal is configured to transmit the emergency alert information detected from the broadcast signal to the external devices 350-1, 350-2, via the home network 310 or the like. Then, each of the external devices 350-1, 350-2, sends out the emergency alert based on the received emergency alert information, so that residents can receive the emergency alert in various locations where the home network 310 is structured even when the residents are distant from the reception device 300.

On the assumption that the external devices 350-1, 350-2, are battery-driven devices such as multi-functional portable terminals, even when the external devices 350-1, 350-2, in the area are concurrently activated, power to be supplied in an emergency alert target area is not short.

The emergency alert information superimposed at the physical layer level of the—broadcast signal includes the extension information extension_data dedicated for the external devices 350, as described above. When url of a location suggesting detailed information regarding the emergency alert is written on the extension_data field, the side of the external devices 350 receiving the emergency alert information can acquire the detailed information regarding the emergency information by an embedded browser via the Internet based on the url and notify neighboring residents of the detailed information regarding the emergency alert. When the text message for the text reading (Text to Speech) by the audio synthesis is written on the extension_data field, the side of the external devices 350 receiving the emergency alert information can inform—neighboring residents of the emergency alert through audio reproduction.

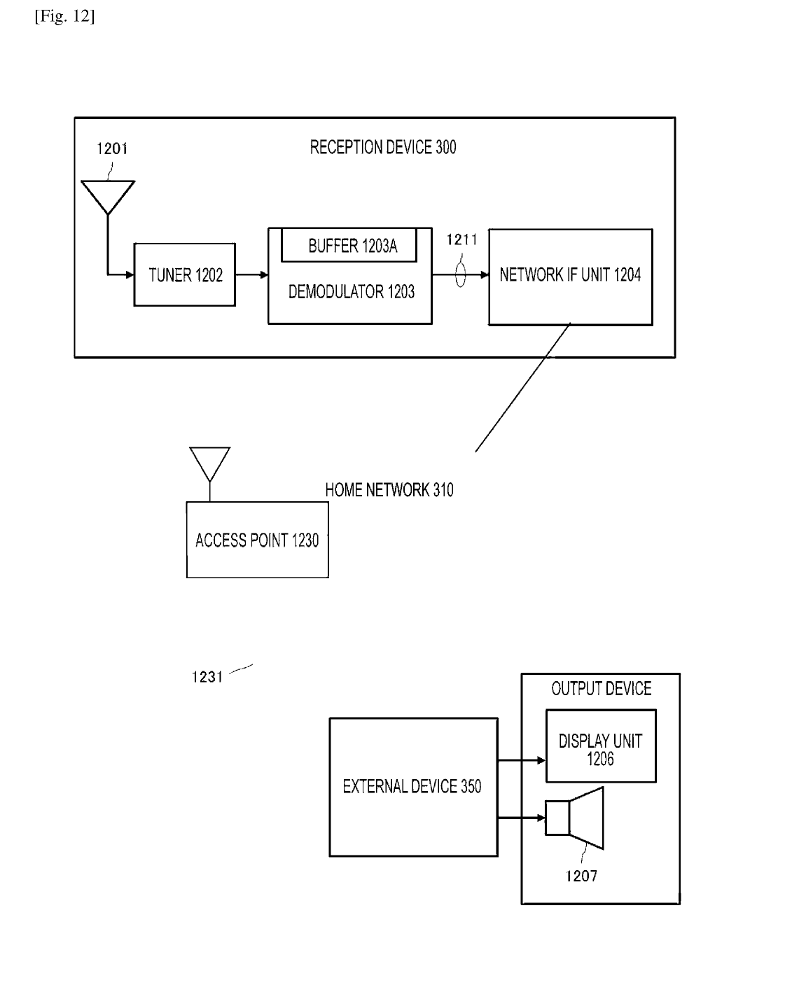

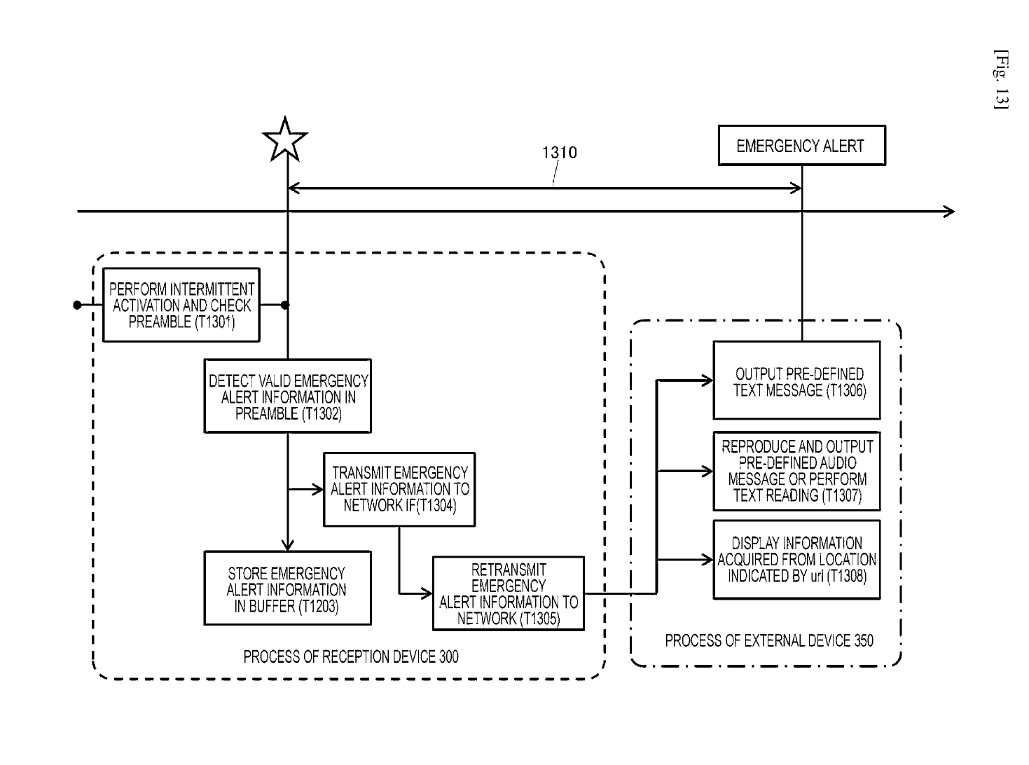

FIG. 12 is a diagram schematically illustrating an inner configuration of the reception device 300 according to another embodiment of the present technology disclosed in the present technology. The illustrated reception device 300 includes an antenna 1201 that receives a broadcast signal, a tuner 1202, a demodulator 1203, and a network interface (IF) unit 1204. The reception device 300 has a simple configuration, and may be a simple broadcast receiver dedicated for an emergency alert or may be embedded in a general television receiver.

The tuner 1202 tunes a component of a predetermined frequency channel from a broadcast signal received by the antenna 1201.

The demodulator 1203 performs a demodulation process on the tuned broadcast signal. In the embodiment, when the demodulator 1203 performs the demodulation process on the preamble section 31 in the transmission frame 30 (or the preamble section 410 in the transmission frame 400) and detects the valid emergency alert information in the preamble section 31 (or the preamble section 410 in the transmission frame 400), the demodulator 1203 outputs the emergency alert information to the network interface unit 1204. The demodulator 1203 includes a buffer 1203A that temporarily retains the detected emergency alert information. The demodulator 1203 does not need to constantly perform the demodulation process to detect the preamble section 31 (or the preamble section 410) and may be intermittently activated and detect the preamble section for power saving.

The demodulator 1203 is connected to the network interface unit 1204 via a control bus 1211 configured by a serial interface such as an I²C (Inter-Integrated Circuit) and controls a communication operation of the network interface unit 1204.

The network interface unit 1204 is connected to the home network 310 to which a technology such as Ethernet (registered trademark) or DLNA is applied via a wired cable 1205. In the home network 310, an access point 1230 in a wireless network 1231 such as Wi-Fi (registered trademark) or Bluetooth (registered trademark) is installed. The access point 1230 subordinates the external devices 350 present inside a cell of the access point 1230 and performs wireless communication. The reception device 300 is mutually connected to the external devices 350 through the home network 310 and the access point 1230 to control the external devices 350.

The external device 350 is, for example, a multi-functional portable terminal such as a smartphone and is driven by a battery. Of course, the external device 350 can also include a CE device driven by a commercial power rather than a battery in the external device 350. The external device 350 includes an output device such as a display unit 1206 formed by a display capable of displaying text, a blinking LED, or the like or a speaker 1207 and can send out an alert.

The reception device 300 can be configured to correspond to the emergency alert information transmitted in any format of the predetermined message mode, the headline message mode, and the digest CAP mode described above.

For example, when the emergency alert information of the predetermined message mode is received, the demodulator 1203 retransmits category information—regarding the received display_message_type or aural_message_type (see FIGS. 5A to 5D) from the network interface unit 1204 to the external device 350. When the emergency alert information of the headline message mode is received, the demodulator 1203 retransmits the received text information from the network interface unit 1204 to the external device 350. When the emergency alert information of the digest CAP mode is received, the demodulator 1203 retransmits the received CAP information from the network interface unit 1204 to the external device 350. Even in any transmission format, url written on the extension data field or the extension information extension data (see FIGS. 5A to 5D) dedicated for the external device 350 described in the received emergency alert information is retransmitted from the network interface unit 1204 to the external device 350 via the home network 310. The emergency alert information retransmitted from the reception device 300 to the external device 350 will be exemplified below.
(1) Category Information by Bitmap
(2) Text Information
(3) CAP Information or Digest Version thereof
(4) url for Accessing the Internet

When the emergency alert information is retransmitted with url, abbreviated url used on the Internet is used in some cases for the purpose of restriction on an amount of information which can be transmitted with the preamble section of the transmission frame (as described above). On the side of the external device 350 receiving the url may access the redirected original url.

A method of retransmitting the emergency alert information to the external device 350 using UPnP (Universal Plug and Play) by the reception device 300 will be considered. First, the reception device 300 performs a device discovery order by using a protocol using UDP (User Datagram Protocol) of the UPnP standard called SSDP (Simple Service Discovery Protocol) and detects the external devices 350 capable of sending out the emergency alert in the home network 310. Then, the reception device 300 transmits the above-described emergency alert information to the external devices 350 according to a unidirectional (one-way) transmission method of UPnP.

Thus, the external devices 350 in the home network 310 can send out the emergency alert according to the emergency alert information based on the content broadcasted from the broadcast station.

The transmission frame used to transmit the emergency alert information from the reception device 300 to the external device 350 may include an automatic activation signal. The external devices 350 in a standby state are activated by the received automatic activation signal to warn that the emergency alert is generated.

FIG. 13 is a diagram illustrating a time chart in which the reception device 300 illustrated in FIG. 12 retransmits the emergency alert information included in the transmission frame received from the transmission device 200 and sends out an emergency alert by the external devices 350.

The demodulator 1203 is intermittently activated and checks data of the preamble section 31 of the transmission frame 30 (or the preamble section 410 of the transmission frame 400) received by the antenna 1201 (T1301).

Then, when the demodulator 1203 detects the valid emergency alert information in the preamble section 31 (or the preamble section 410) (T1302), the demodulator 1203 stores the emergency alert information in the buffer 1203A (T1303) and transmits the emergency alert information to the network interface unit 1204 via the I²C interface 1101 (T1304).

The demodulator 1203 retransmits the emergency alert information from the network interface unit 1204 to the external devices 350 in the home network 310 and instructs the external devices 350 to generate an alert (T1305).

The emergency alert information retransmitted to the external devices 350 includes display_message_type and aural_message_type (see FIG. 5A) described in the emergency alert information transmitted in the format of the predetermined message mode and extension_data (see FIG. 5D) described in the emergency alert information in the external device extension mode. The type of emergency alert information specified with display_message_type and aural_message_type, that is, the category information, may be retransmitted in the bitmap format. Further, extension_data includes text information of the headline text, the CAP information or the digest version thereof, and url used to access the Internet.

Then, the external device 350 outputs the pre-defined text message by reading (Text to Speech) by audio output from the speaker 1207 or by display output from the display unit 1206 (T1306).

The external device 350 reproduces and outputs the pre-defined audio message for aural_message_type transmitted from the demodulator 1003 (T1307). Alternatively, the external device 350 performs reading (Text to Speech) of the text message transmitted as extension data.

The external device 350 displays the more detailed information regarding the emergency alert acquired from the location indicated by url (or abbreviated url) transmitted as extension_data using an embedded browser (T1308).

In FIG. 13, a section denoted by reference numeral 1310 is a necessary time in which the transmission frame reaches the reception device 300 and then the external device 350 sends out the message of the emergency alert information. In the illustrated example, the emergency alert information can be retransmitted to the external devices 350 in a short time through only the process on the physical layer of the transmission frame by the demodulator 1203 and the side of the external devices 350 can output the message of the emergency alert information. For example, when url is retransmitted as the emergency alert information, the external device 350 can access the location indicated by url via the Internet, acquire the more detailed information regarding the emergency alert, and display the more detailed information.

### INDUSTRIAL APPLICABILITY

The present technology disclosed in the present specification has been described in detail with reference to specific embodiments. However, it should be apparent to those skilled in the art that corrections or substitutions of the embodiments may occur within the scope of the present technology without departing from the gist of the present technology disclosed in the present specification.

The present technology disclosed in the present specification can be applied to various types of broadcast systems for broadcasting broadcast content with the transmission frame including the preamble to transmit the emergency alert information. For example, the present technology disclosed in the present specification can be applied to a broadcast system based on the broadcast standard ATSC adopted in the United States of America, but the application scope is not limited thereto. Further, the present technology disclosed in the present specification can be likewise applied to a broadcast system in conformity with a broadcast standard in which data is added to a payload in a format other than the preamble. Furthermore, the present technology disclosed in the present specification can be likewise applied to a wired or wireless communication system of an IP network or the like rather than broadcast.

In short, the present technology disclosed in the present specification has been described according to exemplary modes, and thus the content described in the present specification has not to be interpreted as limited. In order to determine the gist of the present technology disclosed in the present specification, the claims have to be referred.

The present technology described in the present specification can be configured as follows.
(1) A reception device including circuitry configured to:
receive a transmission of a physical layer frame including emergency alert information;
demodulate the received physical layer frame;
detect the emergency alert information; and
provide an alert based on the emergency alert information obtained through the demodulation.
(2) A reception device including circuitry configured to:
receive a transmission of a physical layer frame including emergency alert information;
demodulate the received physical layer frame;
detect the emergency alert information; and
retransmit the emergency alert information obtained through the demodulation to an external device via a communication medium.
(3) The reception device according to (1) or (2), wherein the physical layer frame is transmitted on a broadcast channel assigned to a broadcast station and includes tuning information used to tune to the broadcast channel.
(4) The reception device according to (1) or (2), wherein the circuitry is configured to output audio according to the emergency alert information.
(5) The reception device according to (4), wherein the
circuitry is configured to
store a plurality of audio files,
select one of the plurality of audio files according to a type of the emergency alert information, and
output the selected one of the plurality of audio files.
(6) The reception device according to (4), wherein the circuitry is configured to aurally output a reading of the emergency alert information with a text format.
(7) The reception device according to (1), wherein the circuitry is configured to output visual information according to the emergency alert information.
(8) The reception device according to (2), wherein the emergency alert information to be retransmitted includes text information.
(9) The reception device according to (2), wherein the emergency alert information to be retransmitted includes bitmap information in which audio message is defined.
(10) The reception device according to (2), wherein the emergency alert information to be retransmitted includes CAP (Common Alerting Protocol) information or a digest of the CAP information.
(11) The reception device according to (2), wherein the emergency alert information to be retransmitted includes extension information for the external device.
(12) The reception device according to (2), wherein the emergency alert information to be retransmitted includes a url or an abbreviated url for accessing more detailed information.
(13) The reception device according to (2), wherein the circuitry is configured to retransmit the emergency alert information to the external device which is detected through device discovery according to an UPnP (Universal Plug and Play) standard protocol.
(14) The reception device according to (13), wherein the circuitry is configured to retransmit the emergency alert information to the external device according to an unidirectional (one-way) transmission method of the UPnP.
(15) The reception device according to (2), wherein the physical layer frame used to retransmit the emergency alert information includes an automatic activation signal for automatically activating the external device.
(16) A reception method of a reception device including:
receiving, by circuitry of the reception device, a transmission of a physical layer frame including emergency alert information;
demodulating, by the circuitry, the received physical layer frame;
detecting, by the circuitry, the emergency alert information; and
providing an alert based on the emergency alert information obtained in the demodulating.
(17) A reception method of a reception device including:
receiving, by circuitry of the reception device, a transmission of a physical layer frame including emergency alert information;
demodulating, by the circuitry, the received physical layer frame;
detecting, by the circuitry, the emergency alert information; and
retransmitting the emergency alert information obtained in the demodulating to an external device via a communication medium.
(18) A non-transitory computer-readable storage medium storing a computer program which, when executed by a computer, causes the computer to:
receive a transmission of a physical layer frame including emergency alert information;
demodulate the received physical layer frame;
detect the emergency alert information; and
provide an alert based on the emergency alert information obtained through the demodulation.
(19) A non-transitory computer-readable storage medium storing a computer program which, when executed by a computer, causes the computer to:
receive a transmission of a physical layer frame including emergency alert information;
demodulate the physical layer frame;
detect the emergency alert information; and
retransmit the emergency alert information obtained through the demodulation to an external device via a communication medium.
(20) An external device including circuitry configured to:
receive emergency alert information that is retransmitted by a reception device via a communication medium, and
provide an alert based on the emergency alert information received from the reception device, wherein
the emergency alert information is included in a physical layer frame of a transmission received by the reception device, and
the reception device demodulates the physical layer frame and detects the emergency alert information before the emergency alert information is retransmitted.
(21) The external device described above in (20), wherein reading of text information included in the received emergency alert information may be aurally output.
(22) The external device described above in (20), wherein audio information corresponding to bitmap information included in the received emergency alert information may be reproduced and output.
(23) The external device described above in (20), wherein reading of CAP information included in the received emergency alert information or a digest of the CAP information may be aurally output.
(24) The external device described above in (20), wherein text reading of extension information included in the received emergency alert information may be aurally output.
(25) The external device described above in (20), wherein reading of text information acquired based on a url included in the received emergency alert information may be aurally output.
(26) A transmission device including circuitry configured to:
acquire emergency alert information;
acquire broadcast content;
superimpose the emergency alert information on a physical layer and generate a physical layer frame used to transmit the broadcast content; and
transmit the transmission frame. Extension information for an external device—connected to a reception device receiving the transmission frame is described in the emergency alert information in which the transmission frame is superimposed on the physical layer.
(27) The transmission device described above in (26), wherein the extension information may include a url or an abbreviated url for accessing more detailed information.

### REFERENCE SIGNS LIST

1 Emergency alert information transmission system
100 Information supply device
200 Transmission device
201 Emergency alert information reception unit
202 Emergency alert information processing unit
203 Program content acquisition unit
204 Broadcast signal generation unit
205 Broadcast signal transmission unit
300 Reception device
310 Home network
350 External device
1001 Antenna
1002 Tuner
1003 Demodulator
1003A Buffer
1004 Alert unit
1005 Output unit
1006 Display unit
1007 Speaker
1011 Control bus
1201 Antenna
1202 Tuner
1203 Demodulator
1203A Buffer
1204 Network interface unit
1230 Access point

1. A reception device comprising:
circuitry configured to
receive a transmission of a physical layer frame including emergency alert information;
demodulate the received physical layer frame;
detect the emergency alert information; and
provide an alert based on the emergency alert information obtained through the demodulation.

2. A reception device comprising:
circuitry configured to
receive a transmission of a physical layer frame including emergency alert information;
demodulate the received physical layer frame;
detect the emergency alert information; and
retransmit the emergency alert information obtained through the demodulation to an external device via a communication medium.

3. The reception device according to claim 1, wherein the physical layer frame is transmitted on a broadcast channel assigned to a broadcast station and includes tuning information used to tune to the broadcast channel.

4. The reception device according to claim 1, wherein the circuitry is configured to
output audio according to the emergency alert information.

5. The reception device according to claim 4, wherein the circuitry is configured to
store a plurality of audio files,
select one of the plurality of audio files according to a type of the emergency alert information, and
output the selected one of the plurality of audio files.

6. The reception device according to claim 4, wherein the circuitry is configured to aurally output a reading of the emergency alert information with a text format.

7. The reception device according to claim 1, wherein the circuitry is configured to
output visual information according to the emergency alert information.

8. The reception device according to claim 2, wherein the emergency alert information to be retransmitted includes text information.

9. The reception device according to claim 2, wherein the emergency alert information to be retransmitted includes bitmap information in which audio message is defined.

10. The reception device according to claim 2, wherein the emergency alert information to be retransmitted includes CAP (Common Alerting Protocol) information or a digest of the CAP information.

11. The reception device according to claim 2, wherein the emergency alert information to be retransmitted includes extension information for the external device.

12. The reception device according to claim 2, wherein the emergency alert information to be retransmitted includes a url or an abbreviated url for accessing more detailed information.

13. The reception device according to claim 2, wherein the circuitry is configured to retransmit the emergency alert information to the external device which is detected through device discovery according to an UPnP (Universal Plug and Play) standard protocol.

14. The reception device according to claim 13, wherein the circuitry is configured to retransmit the emergency alert information to the external device according to a unidirectional (one-way) transmission method of the UPnP.

15. The reception device according to claim 2, wherein the physical layer frame used to retransmit the emergency alert information includes an automatic activation signal for automatically activating the external device.

16. A reception method of a reception device, the method comprising:
receiving, by circuitry of the reception device, a transmission of a physical layer frame including emergency alert information;
demodulating, by the circuitry, the received physical layer frame;
detecting, by the circuitry, the emergency alert information; and
providing an alert based on the emergency alert information obtained in the demodulating.

17. A reception method of a reception device, the method comprising:
receiving, by circuitry of the reception device, a transmission of a physical layer frame including emergency alert information;
demodulating, by the circuitry, the received physical layer frame;
detecting, by the circuitry, the emergency alert information; and
retransmitting the emergency alert information obtained in the demodulating to an external device via a communication medium.

18. A non-transitory computer-readable storage medium storing a computer program which, when executed by a computer, causes the computer to:
receive a transmission of a physical layer frame including emergency alert information;
demodulate the received physical layer frame;
detect the emergency alert information; and
provide an alert based on the emergency alert information obtained through the demodulation.

19. A non-transitory computer-readable storage medium storing a computer program which, when executed by a computer, causes the computer to:
receive a transmission of a physical layer frame including emergency alert information;
demodulate the physical layer frame;
detect the emergency alert information; and
retransmit the emergency alert information obtained through the demodulation to an external device via a communication medium.

20. An external device, comprising:
circuitry configured to
receive emergency alert information that is retransmitted by a reception device via a communication medium, and
provide an alert based on the emergency alert information received from the reception device, wherein
the emergency alert information is included in a physical layer frame of a transmission received by the reception device, and
the reception device demodulates the physical layer frame and detects the emergency alert information before the emergency alert information is retransmitted.
